(19) United States
(12) Patent Application Publication
(10) Pub. No.: US 2026/0120489 A1
(43) Pub. Date: Apr. 30, 2026

(54) CONTEXT-AWARE OCR CORRECTION USING LLM

(71) Applicant: SAP SE, Walldorf (DE)

(72) Inventor: Tobias WELLER, Buseck (DE)

(21) Appl. No.: 18/928,491

(22) Filed: Oct. 28, 2024

(51) Int. Cl. G06V 30/12; G06V 30/19; G06V 30/413; G06V 30/416

(52) U.S. Cl. CPC G06V 30/127; G06V 30/19173; G06V 30/413; G06V 30/416

(57) ABSTRACT

Systems and methods include extraction of text data from an image, generation of a prompt including the extracted text data and indicating one or more portions of the extracted text data which represent handwritten text, input of the prompt to a text generation model, and reception of corrected text data from the text generation model in response to the prompt.

### BACKGROUND

Modern organizations store vast amounts of data across one or more data sources. Each data source may employ a data model which defines a logical structure and semantics of its stored data. Enterprise applications leverage this data model to perform operations and analysis on the stored data.

An organization may receive data which does not conform to its data model or to any data model. Due to its “unstructured” nature, it is difficult for an application to perform the aforementioned operations and analysis on such data. It is therefore desirable to convert this unstructured data to a structured format which conforms to a data model of the application, and to store the structured data for use by the application.

Despite the trend toward digital processing, documents remain a significant source of data for many organizations. To convert a document into structured data, the document is scanned to an image, optical character recognition (OCR) is performed to extract text data from the image, and the extracted text is formatted into structured data (e.g., a data structure consisting of fields and corresponding values). Typical documents present several challenges to accurate OCR.

For example, a scanned image may be blurred or otherwise poor-quality, thereby complicating proper recognition of the text characters therein. Documents may also include handwritten text. Handwritten text increases the possibility of confusion between visually-similar characters or digit, such as ‘9’ and ‘g’, the number “1” and the letter “1”, and the letter “O” and the number “0”. Handwritten text may also fail to conform to conventional character forms due to poor handwriting skills, rushed writing caused by time constraints, etc.

If the text extracted from a document is inaccurate, it becomes more difficult to properly generate structured data therefrom, particularly using automated techniques. Accordingly, increased text extraction errors may increase the need for manual intervention in the text extraction process and in the data intake process. Systems are needed to efficiently increase the quality of structured data extracted from documents which include handwritten text.

### BRIEF DESCRIPTION OF THE DRAWINGS

FIG. 1 is a block diagram of an architecture to extract text data from a document image and correct the extracted text data according to some embodiments.

FIG. 2 is a flow diagram of a process to extract text data from a document image and correct the extracted text data according to some embodiments.

FIG. 3 is a document image according to some embodiments.

FIG. 4 shows text data extracted from a document image.

FIG. 5 shows text data extracted from a document image and corrected according to some embodiments.

FIG. 6 is a block diagram of an architecture to extract text data from a document image and correct the extracted text data according to some embodiments.

FIG. 7 is a flow diagram of a process to extract text data from a document image and correct the extracted text data according to some embodiments.

FIG. 8 shows text data extracted from a document image and annotated according to some embodiments.

FIG. 9 shows text data extracted from a document image and corrected according to some embodiments.

FIG. 10 is a block diagram of an architecture to extract text data from a document image and correct the extracted text data according to some embodiments.

FIG. 11 is a flow diagram of a process to extract text data from a document image and correct the extracted text data according to some embodiments.

FIG. 12 is a user interface for selecting a document extraction schema according to some embodiments.

FIG. 13 is a user interface showing a document image prior to text data extraction according to some embodiments.

FIG. 14 is a user interface showing text data extracted based on a document extraction schema according to some embodiments.

FIG. 15 is a block diagram of a hardware environment according to some embodiments.

### DETAILED DESCRIPTION

The following description is provided to enable any person in the art to make and use the described embodiments. Various modifications, however, will be readily-apparent to those in the art.

Some embodiments provide improved extraction of text data from documents, particularly from handwritten document content. Embodiments may correct extracted text data based on the context of the document and/or the manner in which the text of the document was generated. Advantageously, this context-aware approach may efficiently enhance text recognition accuracy and reduce the propagation of errors resulting from inaccurate text recognition.

Briefly, and for example, text data may be extracted from an image of a document. A prompt is generated which includes the extracted text data and indicates that the text data includes handwritten text. The prompt may indicate specific portions of the extracted text data which are estimated to represent handwritten text. The prompt is input to a text generation model, and corrected text data is received from the text generation model in response. A classifier may be used to classify the specific portions of the text data as handwritten.

The prompt may also specify a type of the document and/or information to be identified from the extracted text data. For example, the prompt may instruct the text generation model to output one or more field, value pairs of a schema based on the extracted text data. These field, value pairs may be used to populate a row of a database table which corresponds to the document.

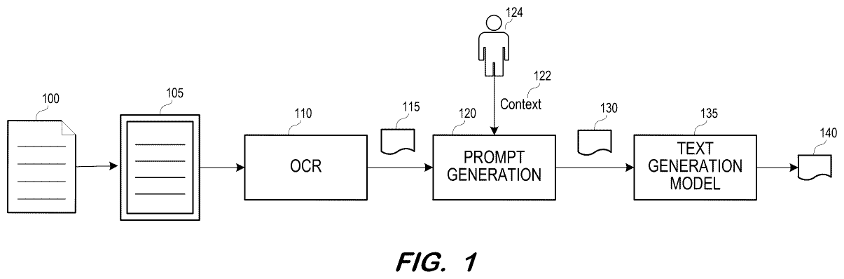

FIG. 1 is a block diagram of an architecture to extract text data from a document image and correct the extracted text data according to some embodiments. Each of the illustrated components may be implemented using any suitable combination of on-premise, cloud-based, distributed (e.g., including distributed storage and/or compute nodes) computing hardware and/or software that is or becomes known. Each computing system described herein may comprise one or more physical and/or virtualized servers.

Two or more components of FIG. 1 may be co-located. In some embodiments, two or more components are implemented by a single computing device. One or more components may be implemented as a cloud service (e.g., Software-as-a-Service, Platform-as-a-Service). A cloud-based implementation of any components of FIG. 1 may apportion computing resources elastically according to demand, need, price, and/or any other metric.

Each component may comprise, for example, comprise a single computer server, a virtual machine, or a cluster of computer servers such as a Kubernetes cluster. Kubernetes is an open-source system for automating deployment, scaling and management of containerized applications. Each component of the FIG. 1 system may therefore be implemented by one or more servers (real and/or virtual) or containers. Each data storage component depicted herein may comprise one or more storage systems, each of which may be standalone or distributed, on-premise or cloud-based.

Physical document 100 may comprise a completed form, a handwritten note, an annotated printed document, and/or any other physical document on which text has been printed. The text of the physical document includes handwritten text and machine-printed text (e.g., printed by a printer, copier, or printing press). The handwritten text may have been added to the physical document well after the machine-printed text was added, for example in the case of a form. The handwritten text may include text written by one or more persons, and may be handwritten in ink, pencil or any other medium.

Document image 105 may be generated by scanning physical document 100 using a scanner, a camera, or other image capture device. Document image 105 may comprise an electronic image including pixels representing the text of document 100.

Document image 105 may conform to any suitable format, including but not limited to .jpg, .png, .bmp, and .pdf.

OCR processor 110 comprises program code executable to generate text data 115 based on document image 105. OCR processor 110 detects the pixels of image 105 which represent text of document 100 and, based on the pixels, generates text data 115 which represents the text of document 100 in an electronic text format (e.g., .txt, .doc, .rtf, .asc). Generation of text data from an image may be referred to as extraction of the text data. OCR processor 110 may executable any OCR algorithms that are or become known and may utilize one or more trained machine-learning models.

Prompt generation component 120 generates prompt 130 based on text data 115 and context 122 received from user 124. As is known in the art, a prompt includes instructions which describe a text output desired from a text generation model. A prompt may also include information which the text generation model may use to assist generation of the desired text output. Prompt generation component 120 may generate prompt 130 by populating a prompt template, or “system prompt”, with text of a “user prompt” such as context 122. Examples of context 122 are provided below.

Below is an example of a system prompt according to some embodiments. Prompt generation component 120 may generate prompt 130 by populating the field <document description> of the system prompt with context 122 and populating the field <extracted text> of the system prompt with text data 115.

“The following text was extracted from a document by an OCR system. <document description>
<extracted text>
Some of the extracted text is handwritten and may include errors due to poor handwriting. Correct the extracted text and return the corrected text.”

Prompt generation component 120 inputs prompt 130 to text generation model 135 using known protocols. Text generation model 135 may comprise a neural network trained to generate text based on input text. Text generation model 135 may be implemented by, for example, executable program code, a set of hyperparameters defining a model structure and a set of corresponding weights, or any other representation of an input-to-output mapping which was learned as a result of the training. According to some embodiments, model 135 is a Large Language Model (LLM) conforming to a transformer architecture. A transformer architecture may include, for example, embedding layers, feedforward layers, recurrent layers, and attention layers. Generally, each layer includes nodes which receive input, change internal state according to that input, and produce output depending on the input and internal state. The output of certain nodes is connected to the input of other nodes to form a directed and weighted graph. The weights as well as the functions that compute the internal states are iteratively modified during training.

An embedding layer creates embeddings from input text, intended to capture the semantic and syntactic meaning of the input text. A feedforward layer is composed of multiple fully-connected layers that transform the embeddings. Some feedforward layers are designed to generate representations of the intent of the text input. A recurrent layer interprets the tokens (e.g., words) of the input text in sequence to capture the relationships between the tokens. Attention layers may employ self-attention mechanisms which are capable of considering different parts of input text and/or the entire context of the input text to generate output text.

Non-exhaustive examples of trained text generation model 135 include GPT-4, LaMDA, Claude or the like. Model 135 may be publicly available or deployed within a landscape which is trusted by a provider of prompt generation component 120. Similarly, text generation model 135 may be trained based on public and/or private data.

Based on its training and on prompt 130, text generation model 135 outputs corrected text data 140. Corrected text data 140 may include corrections to text data 115. Examples of such corrections will be provided below. Corrected text data 140 may conform to any suitable text data format.

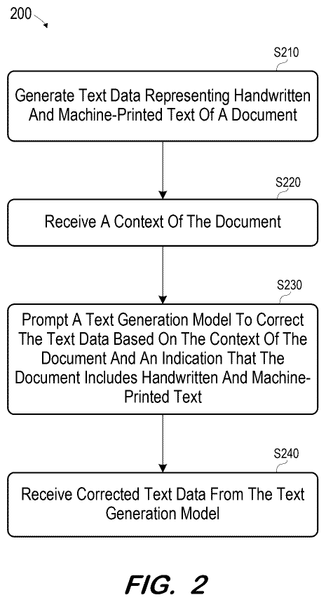

FIG. 2 comprises a flow diagram of process 200 to extract text data from a document image and correct the extracted text data according to some embodiments. Process 200 and the other processes described herein may be performed using any suitable combination of hardware and software. Program code embodying these processes may be stored by any one or more non-transitory tangible media, including but not limited to a fixed disk, a volatile or non-volatile random-access memory, a DVD, a Flash drive, and a magnetic tape, and executed by any one or more processing units, including but not limited to a processor, a processor core, and a processor thread.

Embodiments of process 200 are not limited to the examples described below.

At S210, text data representing handwritten and machine-printed text of a document is generated. S210 may comprise performing OCR processing on an image of a document which includes handwritten and machine-printed text. Any OCR processing that is or becomes known may be used at S210. The text data is generated in an electronic format suitable for representing text (e.g.,. txt). In some embodiments, S210 also comprises creating the image of the document, for example by scanning the document.

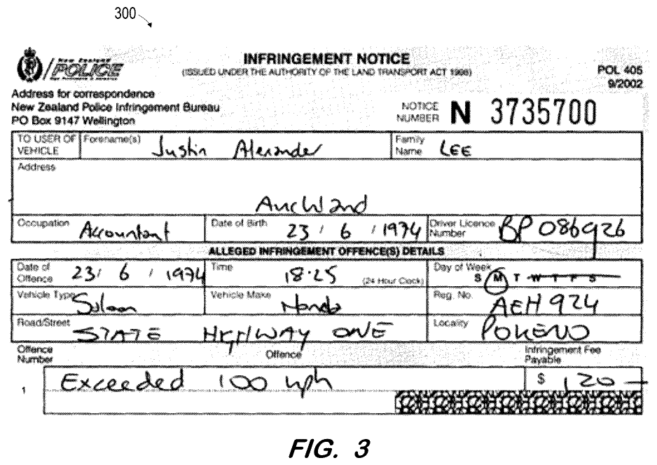

FIG. 3 depicts image 300 of a document according to some examples. As can be seen from image 300, the document is an Infringement Notice related to vehicle operation and includes machine-printed and handwritten text. Generally, the document includes fields identified by machine-printed text and text which is handwritten into the various fields.

FIG. 4 includes text data 400 generated based on image 300 according to some embodiments. Text data 400 includes several errors, e.g., “Jushn”, “VERICLE” “AncW and” “Licen”, “Slon”, “Honde”, “uph”, which do not correctly represent the text (both handwritten and machine-printed) of image 300.

A context of the document is received at S220. The context may comprise a description of the document, a description of the text of the document and/or a description of particular text of interest within the document. The context is intended to provide a text generation model with information which might be useful for identifying and correcting errors within the text data. The context may be input by a user or determined based on the generated text data. According to the present example, a user may input a context such as “This is a speeding ticket” at S220.

Next, at S230, a text generation model is prompted to correct the text data based on the context of the document and an indication that the document includes handwritten and machine-readable text. In some embodiments of S230, a prompt template is populated with the text generated in S210 and with the context received at S220. The prompt template may also include a statement such as “Some of the extracted text is handwritten and may include errors due to poor handwriting. Correct the extracted text and return the corrected text.”

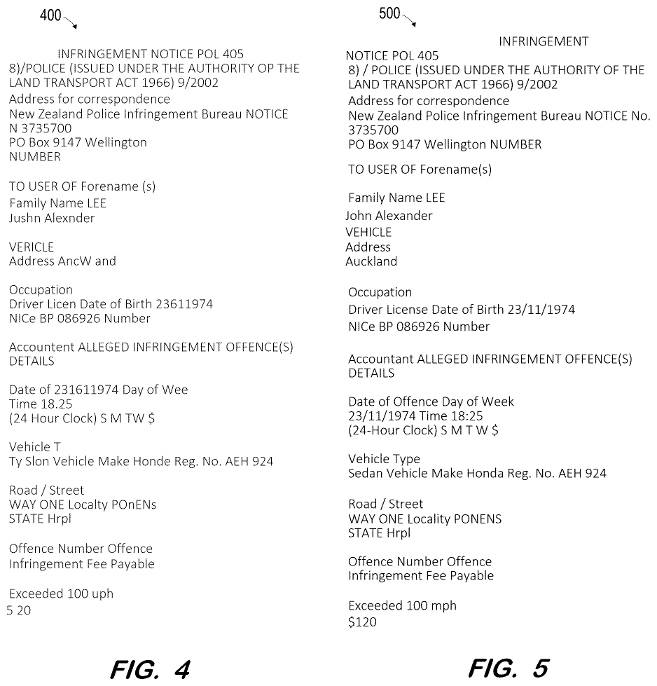

Corrected text is received from the text generation model at S240. FIG. 5 shows corrected text data 500 according to the present example. For example, “AncW and” has been corrected to “Auckland”, “VERICLE” has been corrected to “VEHICLE”, “Honde” has been corrected to “Honda”, and “uph” has been corrected to “mph”. Embodiments of process 200 may therefore provide improved text data extraction.

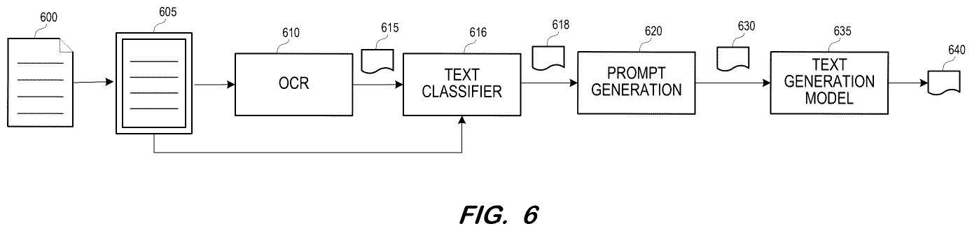

FIG. 6 is a block diagram of an architecture to extract text data from a document image and correct the extracted text data according to some embodiments. The FIG. 6 system may present a smaller likelihood of erroneously modifying correctly-extracted text data than the FIG. 1 system.

Document 600 may comprise a physical document as described above, and image 605 may comprise an image of document 600. OCR processor 610 extracts text data 615 from document image 605. In contrast to FIG. 1, text classifier 616 receives text data 615 and identifies portions of text data 615 which correspond to handwritten text of document 600. This identification utilizes pixels of image 605 which correspond to the various portions of text data 615.

Text classifier 616 may comprise a trained classification model as is known in the art. For each token of text data 615, text classifier 616 may output a class likelihood (i.e., percentage) for each of the classes handwritten and machine-printed. A token may comprise a letter, a word, a phrase, etc.

Annotated text data 618 includes identifiers of the classifications determined by text classifier 616. For example, each word of text data 618 which is classified as being handwritten (i.e., generated based on handwritten text of document 600) may be tagged with the identifier “(HW)”. Prompt generation model 620 generates prompt 630 based on annotated text data 618. For example, prompt 630 may read as follows:

“The following text was extracted from a document by an OCR system.
<extracted text>
Some of the extracted text is handwritten and may include errors due to poor handwriting. Each word that is handwritten precedes the indicator “(HW)”. Correct the errors in the extracted text and only consider the handwritten words for correction.”

According to some embodiments, prompt 630 may also include a context as described with respect to FIG. 1. Text generation model 635 outputs corrected text data 640 in response to prompt 630. Corrected text data 640 may include corrections to portions of text data 615 which represent handwritten text.

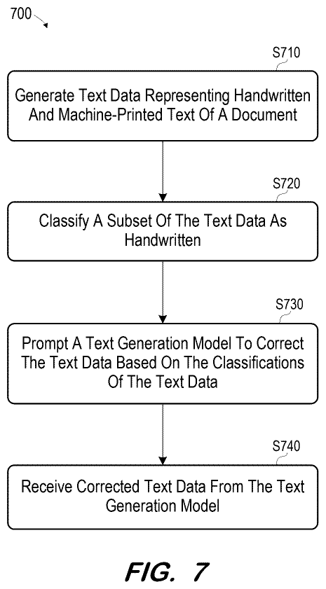

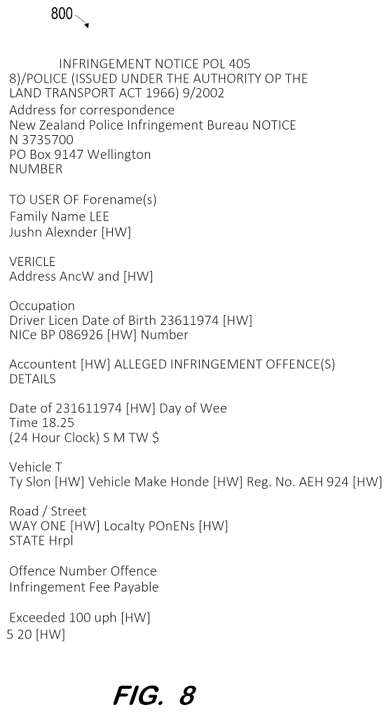

FIG. 7 is a flow diagram of process 700 according to some embodiments. Process 700 may be implemented by the components of FIG. 6 in some embodiments. Text data representing handwritten and machine-printed text of a document is generated at S710. Next, a subset of the text data is classified as handwritten at S720. S720 may include submitting the text data and an image of the document to a trained classification model. The model may provide an output which indicates the characters, words, and/or other portions of the text data which represent handwritten text of the document.

At S730, a text generation model is prompted to correct the text data generated at S710 based on the classifications of the text data. S730 may comprise annotating the text data to indicate those portions which represent handwritten text of the document.

FIG. 8 shows text data 800, which is an annotated version of text data 400 according to some embodiments. As shown, the tag “[HW]” follows text portions which were deemed at S720 to represent handwritten text.

S730 may also comprise generating a prompt including the annotated text data and a request to correct only text data which represents handwritten text. The prompt may include a description of the document and/or other contextual information.

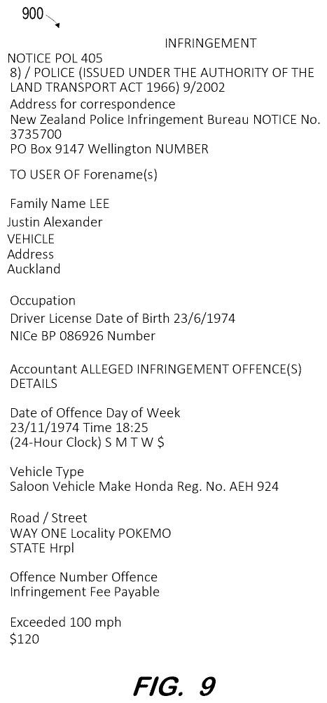

Corrected text data is received from the text generation model at S740. FIG. 9 is an example of corrected text data 900 received at S740 according to some embodiments. As shown, text data “Jushn Alexnder”, “AncW and”, “Driver Licen Date of Birth 23611974”, “uph” and “5 20”, which were marked with [HW] in text data 800, have been corrected, respectively, to “Justin Alexander”, “Auckland”, “Driver License Date of Birth 23Jun. 1974”, “mph” and “$120”. Notably, no text data of text data 800 which was not marked with [HW] has been modified in text data 900.

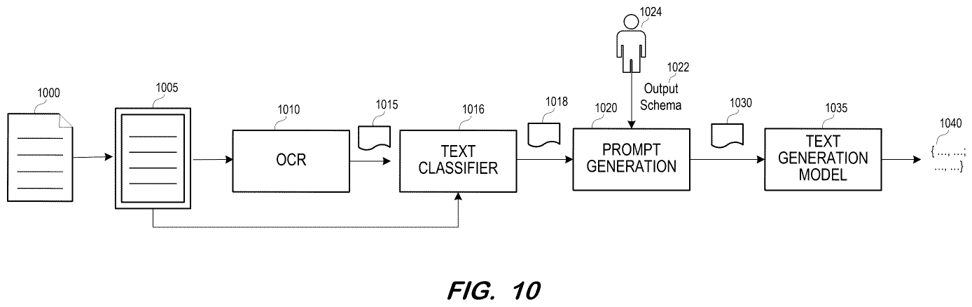

FIG. 10 is a block diagram of an architecture to extract text data from a document image and correct the extracted text data according to some embodiments. The FIG. 6 system may present a smaller likelihood of erroneously modifying correctly-extracted text data than the FIG. 1 system and also facilitate population of data instances based on corrected text data.

Image 1005 comprises an image of document 1000. OCR processor 1010 extracts text data 1015 from document image 1005 and provides text data 1015 to text classifier 1016. Text classifier 1016 outputs annotated text data 1018 which identifies words of text data 1015 which have been classified as being handwritten, or generated based on handwritten text of document 1000.

Prompt generation model 1020 generates prompt 1030 based on annotated text data 1018 and on output schema 1022 provided by user 1024. Prompt 1030 may also include instructions to correct annotated text data 1018 as described above and to output particular data in a particular format based on schema 1022.

Text generation model 1035 outputs corrected and formatted data 1040 in response to prompt 1030. Data 1040 may conform to schema 1022 and may specify one or more fields and one or more values for each of the one or more fields. Consequently, data 1040 may be imported into a data storage system which conforms to schema 1022 with minimal or no manual effort.

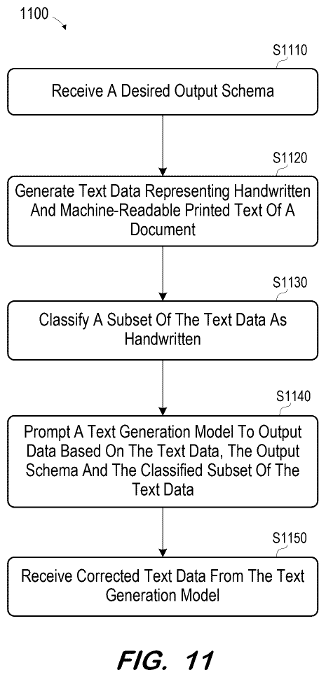

FIG. 11 is a flow diagram of process 1100 according to some embodiments. Process 1100 may be implemented by the components of FIG. 10 in some embodiments.

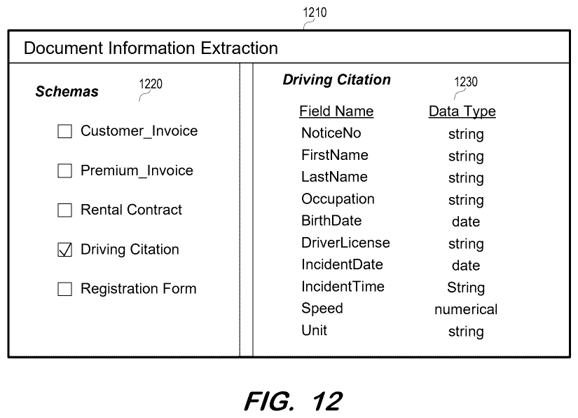

A desired output schema is received at S1110. The output schema may be received from a user operating a user interface such as interface 1210 of FIG. 12. Embodiments are not limited to interface 1210. Interface 1210 may comprise an interface of an application including the components of FIG. 10. In one example, user 1024 executes a Web browser executing on a user device to access the application via HyperText Transfer Protocol and to receive user interface 1210 in return.

User interface 1210 includes list 1220 of schemas which may be used to extract information from a document. Embodiments are not limited to list 1220. The schema Driving Citation has been selected and field metadata 1230 of the schema is therefore presented. A schema may include metadata other than that shown in FIG. 12.

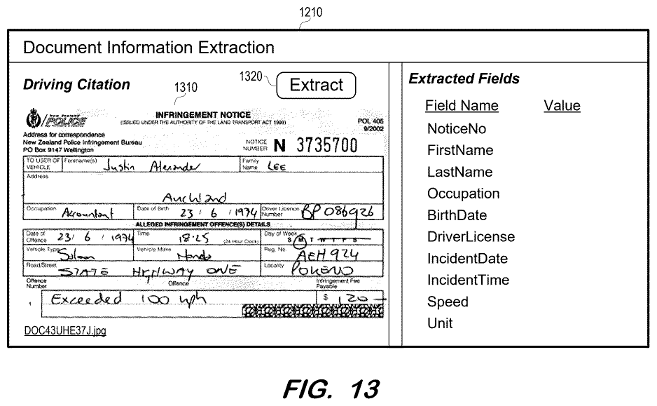

S1110 may also include specifying an image of a document from which text data is to be extracted. FIG. 13 shows user interface 1210 presenting document image 1310 which has been selected for processing. A user may select control 1320 to initiate the extraction of text data from document image 1310. In response to selection of control 1320, text data representing handwritten and machine-printed text of a document is generated at S1120. Next, a subset of the text data is classified as handwritten at S1130 as described above.

At S1140, a text generation model is prompted to output data based on the text data generated at S1120, the output schema and the classified subset of the text data. S1140 may comprise annotating the text data to indicate those portions which represent handwritten text of the document. S1140 may also comprise generating a prompt requesting particular data in a particular format conforming to the output schema, including the annotated text data and including a request to correct only text data which represents handwritten text. The prompt may include a description of the document and/or other contextual information. A prompt for use at S1140 according to some embodiments may be as follows:

“Given the following text extracted from a document, extract information as described below.
<annotated text>
Some of the extracted text is handwritten and was extracted by an OCR system, therefore many words include mistakes due to poor handwriting. Wherever possible, correct the mistaken words and predict a good fit for the words taking typical OCR mismatches into consideration. The parts of the text that are handwritten are marked with “[HW]”. Only consider those marked parts for correction.
Extract the following entities and return the response in CSV format: [{“Name”: “Speed_limit”, “Type”: “number”}, {“Name”: “Unit”, “Type”: “unit”}]”

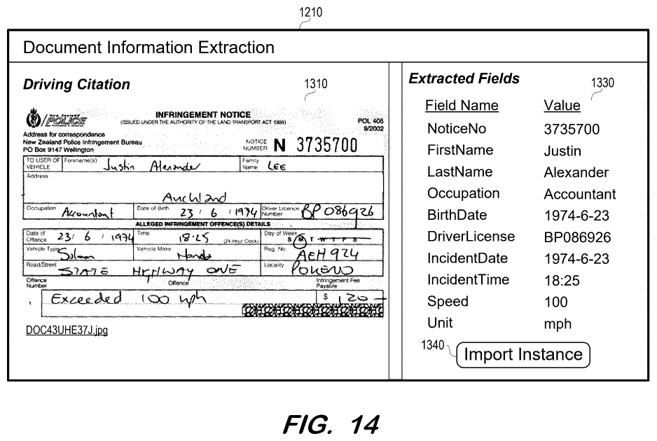

Corrected text data formatted according to the schema is received from the text generation model at S1150. For example, value column 1330 of FIG. 14 includes text data received at S1150 according to some embodiments. Each entry of column 1330 corresponds to a field of the selected schema and was returned in conjunction with its corresponding field at S1150 as described above.

Interface 1210 also includes Import Instance control 1340. According to some embodiments, selection of control 1340 causes creation of a database table row including the values of value column 1330, with each value being stored in a corresponding column of the database table. Embodiments may therefore facilitate capture of structured data conforming to a suitable schema based on a document image.

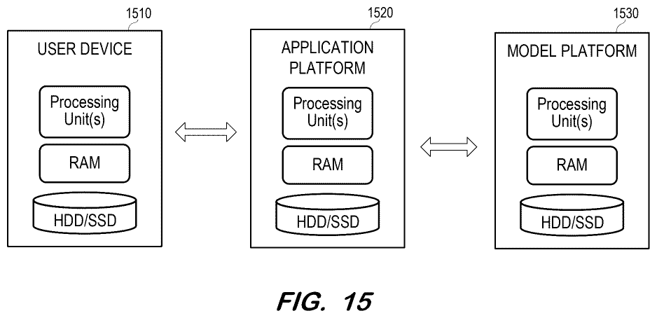

FIG. 15 is a block diagram of a cloud-based system according to some embodiments. Application platform 1520 and model platform 1530 may each comprise cloud-based resources, such as virtual machines, allocated by a cloud provider providing self-service and immediate provisioning, autoscaling, security, compliance and identity management features.

User device 1510 may interact with a user interface of an application executing on application platform 1520, for example via a Web browser executing on user device 1510. A request to extract text data from a document image may submitted to the application via the user interface. In response, application platform 1520 may generate a prompt indicating that the document image includes handwritten text and transmit the prompt to a text generation model executing on model platform 1530. Model platform 1530 receives the prompt and returns text data to application platform 1520.

The foregoing diagrams represent logical architectures for describing processes according to some embodiments, and actual implementations may include more, or different components arranged in other manners. Other topologies may be used in conjunction with other embodiments. Moreover, each component or device described herein may be implemented by any number of devices in communication via any number of other public and/or private networks. Two or more of such computing devices may be located remote from one another and may communicate with one another via any known manner of network(s) and/or a dedicated connection. Each component or device may comprise any number of hardware and/or software elements suitable to provide the functions described herein as well as any other functions. For example, any computing device used in an implementation some embodiments may include a processing unit to execute program code such that the computing device operates as described herein.

Embodiments described herein are solely for the purpose of illustration. Those in the art will recognize other embodiments may be practiced with modifications and alterations to that described above.

What is claimed is:

1. A system comprising:
a memory storing program code; and
one or more processing units to execute the program code to cause the system to:
acquire text data extracted from an image;
generate a prompt including the extracted text data, instructions to correct the text data and indicating that the text data includes handwritten text;
input the prompt to a text generation model; and
receive corrected text data from the text generation model in response to the prompt.

2. The system of claim 1, wherein the image is an image of a document, and
wherein the prompt includes a description of the document.

3. The system of claim 2, the one or more processing units to execute the program code to cause the system to:
classify one or more portions of the text data as handwritten,
wherein the prompt indicates the one or more portions which are classified as handwritten.

4. The system of claim 1, the one or more processing units to execute the program code to cause the system to:
classify one or more portions of the text data as handwritten,
wherein the prompt indicates the one or more portions which are classified as handwritten.

5. The system of claim 1, the one or more processing units to execute the program code to cause the system to:
receive a schema comprising a plurality of fields,
wherein the prompt includes the plurality of fields, and
wherein reception of the corrected text data comprises reception of one or more field, text data pairs.

6. The system of claim 5, the one or more processing units to execute the program code to cause the system to:
create a database table row based on the one or more field, text data pairs.

7. The system of claim 5, the one or more processing units to execute the program code to cause the system to:
classify one or more portions of the text data as handwritten,
wherein the prompt indicates the one or more portions which are classified as handwritten.

8. The system of claim 7, wherein the image is an image of a document, and
wherein the prompt includes a description of the document.

9. A method comprising:
extracting text data from an image;
generating a prompt including the extracted text data and indicating one or more portions of the extracted text data which represent handwritten text;
inputting the prompt to a text generation model; and
receiving corrected text data from the text generation model in response to the prompt.

10. The method of claim 9, wherein the image is an image of a document, and
wherein the prompt includes a description of the document.

11. The method of claim 10, further comprising:
inputting the image and the extracted text data to a classifier to classify the one or more portions of the text data as handwritten text.

12. The method of claim 9, further comprising:
inputting the image and the extracted text data to a classifier to classify the one or more portions of the text data as handwritten text.

13. The method of claim 9, further comprising:
receiving a schema comprising a plurality of fields,
wherein the prompt includes the plurality of fields, and
wherein receiving the corrected text data comprises receiving one or more field, text data pairs.

14. The method of claim 13, further comprising:
creating a database table row based on the one or more field, text data pairs.

15. The method of claim 13, further comprising:
inputting the image and the extracted text data to a classifier to classify the one or more portions of the text data as handwritten text.

16. The method of claim 15, wherein the image is an image of a document, and
wherein the prompt includes a description of the document.

17. One or more non-transitory media storing program code executable by one or more processing units of a computing system to cause the computing system to:
receive text data extracted from an image;
generate a prompt including the extracted text data and indicating one or more portions of the extracted text data which represent handwritten text;
input the prompt to a text generation model; and
receive corrected text data from the text generation model in response to the prompt.

18. The one or more non-transitory media of claim 17, the program code executable by one or more processing units of a computing system to cause the computing system to:
input the image and the extracted text data to a classifier to classify the one or more portions of the text data as handwritten text.

19. The one or more non-transitory media of claim 18, the program code executable by one or more processing units of a computing system to cause the computing system to:
receive a schema comprising a plurality of fields, the prompt including the plurality of fields, and receipt of the corrected text data comprising receipt of one or more field, text data pairs; and
create a database table row based on the one or more field, text data pairs.

20. The one or more non-transitory media of claim 17, the program code executable by one or more processing units of a computing system to cause the computing system to:
receive a schema comprising a plurality of fields, the prompt including the plurality of fields, and receipt of the corrected text data comprising receipt of one or more field, text data pairs; and
create a database table row based on the one or more field, text data pairs.
